(19) United States
(12) Patent Application Publication
(10) Pub. No.: US 2013/0118332 A1
(43) Pub. Date: May 16, 2013

(54) PORTABLE VARIABLE-ANGLE CUTTING GUIDE

(71) Applicant: Nicholas John Barnes, Chelsea (AU)

(72) Inventor: Nicholas John Barnes, Chelsea (AU)

(21) Appl. No.: 13/811,270

(22) PCT Filed: Jul. 21, 2010
(86) PCT No.: PCT/AU2010/000927

§ 371 Date: Jan. 19, 2013

(51) Int. Cl. B27B 27/08; B27B 9/04

(52) U.S. Cl. CPC B27B 27/08; B27B 9/04
USPC 83/745; 29/428

(57) ABSTRACT

A portable cutting-guidance apparatus is used with a portable, hand-holdable power saw (20) to make an angle-cut in an object at a variably selected angle. A positioning device (300) is positioned motionless against the object being cut. The saw (20) travels on and along a cutting-guide (100) in a straight line. The linear cutting-guide 100 is pivotally connected to the positioning device 300 about a pivot point (400). The linear cutting guide (100) can be adjustably fastened to the positioning means (300) at a variably selected angle. The apparatus is able to be configured to have, as alternatives, either a right-hand and left-hand portable power saw attached for use with the apparatus.

### FIELD OF INVENTIONS

The present invention relates to variable-angle cutting guides which enable a user to guide a hand-held power cutting tool, such as a portable electric saw or router, to make a straight, linear cut which is at an angle.

The present invention specifically excludes use with non-portable power tools which are not originally designed for, and which cannot ordinarily be used as a hand-held portable tool.

### BACKGROUND

When using a portable hand-held circular power saw to make a linear or straight cut in an object, such a piece of timber, the user pushes the power saw forwards by hand, along a linear path, to make the straight cut.

The prior art includes known saw guides that have a linear guide intended to help the user make straight cuts with a hand-held, portable, power saw.

Prior art examples of such saw guides are seen in U.S. Pat. No. 6,752,059 (Posont), U.S. Pat. No. 6,708,422 (Stojanovski) and U.S. Pat. No. 3,645,307 (Stocker).

An object of the present invention is to provide an improved variable-angle cutting guide.

Description and discussion of prior art in this specification should not be taken as an admission that any one, or any combination of prior art, is part of the common general knowledge of the skilled addressee.

### SUMMARY OF INVENTION

According to the present invention, there is provided a portable cutting-guidance apparatus adapted to be used with a portable power cutting-tool that has a cutting implement to enable the cutting-tool to cut an object at a variably selected angle, including:

portable positioning means adapted, in use, to be positioned motionless against an object to be cut by a portable power cutting-tool; and

a linear cutting-guide adapted to enable the portable power cutting-tool to travel on and along the cutting-guide in a straight line, the cutting-guide being provided with a cutting-tool support adapted to travel and reciprocate along the cutting-guide, and adapted to have the portable cutting-tool attachable thereto,

the cutting-tool support having tool-attachment-means that allows the portable power cutting-tool to be removably attachable thereto, such that the cutting-tool support, when the portable power cutting-tool is so attached, is able to reciprocate back and forth along the cutting-guide,

the cutting-guide being pivotally connected to the positioning means about a pivot point by a variable-angle mechanism that is adapted to adjustably fasten the cutting-guide to the positioning means at a variably selected angle relative to one another such that, in use, the portable power cutting-tool is able to travel on and along the cutting-guide to cut the object in a straight line at the variably selected angle;

wherein the apparatus is able to be configured and arranged to have as alternatives either a right-hand and left-hand portable power cutting-tool attached to the cutting-tool support for use with the apparatus.

Preferably, the cutting-tool support is provided with right-saw-and-left-saw-configuration-means that enables the cutting-tool support to be configured and arranged to have as alternatives either a right-hand and left-hand portable power cutting-tool attached to the cutting-tool support.

Preferably, the right-saw-and-left-saw-configuration-means includes both right and left configuration-means for the following:

the cutting-tool support and the tool-attachment-means therefor; and

the variable-angle mechanism;

such that the portable cutting-guidance apparatus is able to be alternatively configured or re-configured between either a first arrangement adapted for use with a right-hand-saw and a second-arrangement adapted for use with a left-hand-saw.

Preferably, the right-saw-and-left-saw-configuration-means for the tool-attachment-means includes clamping members for attaching either the right-hand or left-hand saw to the cutting-tool support, the clamping members alternatively attachable to the cutting-tool support in either the first or second arrangements.

Preferably, the right-saw-and-left-saw-configuration-means for the variable-angle mechanism includes fastening means for releasably fastening the variable-angle mechanism to the cutting-guide at a location proximate one end thereof, and further fastening means for releasably fastening the variable-angle mechanism as an alternative to the cutting-guide at another location that is proximate the other end of cutting-guide.

Preferably, the cutting-tool support in the right-hand arrangement has a leading edge and a trailing edge, whereupon, after the conversion, the leading edge in the right-hand arrangement becomes the trailing edge in the left-hand arrangement.

Preferably, the linear cutting-guide is symmetrical about its longitudinal axis.

Preferably, the portable positioning means including an abutment surface adapted, in use, to abut the object so as to position the positioning means motionless relative to the object, and the positioning means adapted, in use, to be positioned and held against the object by manual force of the user, the manual force including force with which the user pushes the portable power cutting-tool forwards along the cutting-guide to cut the object,

wherein, in use, when the cutting-tool is attached to the linear saw guide, the user is able to lift and operate with one hand the entire portable cutting-guidance apparatus as one integral unit with the cutting-tool attached,

wherein the linear cutting-guide has a leading edge which, in use, is closest to the cutting implement,

wherein the pivot point is distanced from the leading edge of the cutting-guide such that the entire leading edge is able to pivot around and about the pivot point,

wherein, when the portable cutting-tool is attached to the cutting-tool support, the cutting implement is distanced from the leading edge of the cutting-guide by a measure that exceeds said distance between the pivot point and the leading edge of the cutting-guide such that the cutting implement has a line of cut that passes as close as practically possible to the pivot point in order that, when the positioning means is held against the object by the manual force of the user so as to allow cutting of the object at a certain point, the apparatus enables the user to adjust the selected angle of the apparatus without significantly altering said point at which the object is cut,

wherein the positioning means is adapted, in use, to be positioned and held against the object without requiring a locking means that would otherwise lock the positioning means to the object,

wherein the user is able to lift the integral unit by grasping the cutting-tool in a manner in which the cutting-tool is designed to be handled as a portable tool, and

wherein the power cutting-tool is a saw, and wherein the blade of the saw is as close as practically possible to the pivot point depending on the size of the housing of the saw.

Preferably, the pivot point is located on the positioning means, and wherein the pivot point is distanced from an intersection of the cutting-guide and the positioning means.

Preferably, the variable-angle mechanism includes a curved-support which supports the cutting-guide as the cutting-guide pivots relative to the positioning means through a range of selectable angles.

According to another aspect of the present invention, there is provided a method of configuring a portable cutting-guidance apparatus which is adapted to be used with a portable power cutting-tool that has a cutting implement to cut an object at a variably selected angle, and in which the apparatus includes:

portable positioning means adapted, in use, to be positioned motionless against an object to be cut by a portable power cutting-tool; and

a linear cutting-guide adapted to enable the portable power cutting-tool to travel on and along the cutting-guide in a straight line, the cutting-guide being provided with a cutting-tool support adapted to travel and reciprocate along the cutting-guide, and adapted to have the portable cutting-tool attachable thereto,

the cutting-tool support having tool-attachment-means that allows the portable power cutting-tool to be removably attachable thereto, such that the cutting-tool support, when the portable power cutting-tool is so attached, is able to reciprocate back and forth along the cutting-guide,

the cutting-guide being pivotally connected to the positioning means about a pivot point by a variable-angle mechanism that is adapted to adjustably fasten the cutting-guide to the positioning means at a variably selected angle relative to one another such that, in use, the portable power cutting-tool is able to travel on and along the cutting-guide to cut the object in a straight line at the variably selected angle;

the method includes configuring and arranging the apparatus in order to attach, as an alternative, either a right-hand and left-hand portable power cutting-tool to the cutting-tool support for use with the apparatus.

Preferably, the method includes using right-saw-and-left-saw-configuration-means of the cutting-tool support to configure and arrange the apparatus to enable a right-hand and left-hand portable power cutting-tool, as alternatives, to be attached to the cutting-tool support.

Preferably, the right-saw-and-left-saw-configuration-means includes both right and left configurations for the following:

the cutting-tool support and the tool-attachment-means therefor; and

the variable-angle mechanism;

and wherein the method includes using the right-saw-and-left-saw-configuration-means to alternatively configure or re-configure the apparatus between either a first arrangement adapted for use with a right-hand-saw and a second-arrangement adapted for use with a left-hand-saw.

Preferably, the method includes using clamping members of the tool-attachment-means to attach either a right-hand or left-hand saw to the cutting-tool support, such that the clamping members are alternatively attached to the cutting-tool support in either the first or second arrangements.

Preferably, the method includes, for the right hand arrangement, using fastening means of the right-saw-and-left-saw-configuration-means to releasably fasten the variable-angle mechanism to the cutting-guide at a location proximate one end thereof, and, for the left hand arrangement, using further fastening means of the right-saw-and-left-saw-configuration-means to releasably fasten the variable-angle mechanism to the cutting-guide at another location that is proximate the other end of cutting-guide.

According to a further aspect of the present invention, there is provided a portable cutting-guidance apparatus adapted to be used with a portable power cutting-tool that has a cutting implement to enable the cutting-tool to cut an object at a variably selected angle, including:

portable positioning means adapted, in use, to be positioned motionless against an object to be cut by a portable power cutting-tool; and

a linear cutting-guide adapted to enable the portable power cutting-tool to travel on and along the cutting-guide in a straight line, the cutting-guide being provided with a cutting-tool support adapted to travel and reciprocate along the cutting-guide, and adapted to have the portable cutting-tool attachable thereto,

the cutting-tool support having tool-attachment-means that allows the portable power cutting-tool to be removably attachable thereto, such that the cutting-tool support, when the portable power cutting-tool is so attached, is able to reciprocate back and forth along the cutting-guide,

the cutting-guide being pivotally connected to the positioning means about a pivot point by a variable-angle mechanism that is adapted to adjustably fasten the cutting-guide to the positioning means at a variably selected angle relative to one another such that, in use, the portable power cutting-tool is able to travel on and along the cutting-guide to cut the object in a straight line at the variably selected angle;

wherein the apparatus is provided with saw-tilt-means that enables the saw blade, in use, to be tilted such that the plane of the saw blade is substantially non-perpendicular with respect to the support plane of the cutting-tool support.

### DRAWINGS

In order that the present invention might be more fully understood, embodiments of the invention will be described, by way of example only, with reference to the accompanying drawings, in which:

FIG. 1 shows an embodiment of a portable, variable-angle saw guide of the present invention which has a track-runner mounted on the track, and in which a saw is attached to the saw guide by being initially attached to the track-runner;

FIG. 2 illustrates the same embodiment as FIG. 1, except with the track-runner positioned at the upper-end of the track: the end which, in use, would be furthest from the user;

FIG. 3 shows a plan view of the embodiment of FIG. 1 except with the saw removed in order to reveal the structure of the track-runner to which the saw is attachable;

FIG. 4 shows the configuration of FIG. 3 seen from the under-surface view;

FIGS. 5 and 6 show the embodiment of FIG. 1 with the saw guide arranged at different angles in each instance to achieve an angle cut;

FIG. 7 is a perspective view of the embodiment of FIG. 1 showing the saw mounted on the track-runner, with the track-runner positioned at the lower-end or start of the track: the end which, in use, would be closest to the user;

FIG. 8 is a perspective view of the same embodiment of FIG. 1, except here the track-runner and saw are shown positioned at the upper-end or the finish of the track;

FIG. 9 shows a perspective view of the same embodiment of FIG. 1, except here the track-runner is illustrated without the saw mounted thereon, so that features of the track-runner can be seen. (In this figure, the outline of the object to be cut is shown in one dimension for simplicity, without showing the object's height);

FIG. 10 is a perspective view showing an embodiment of a mechanism used to attach a saw to the side platform of the embodiment of FIG. 1;

FIG. 11 is a side view of the saw guide of the embodiment in FIG. 1;

FIG. 12 is a front view of the saw guide of the embodiment in FIG. 1;

FIG. 13 shows a front view of an embodiment of a track-runner, illustrated when it is mounted on the track;

FIG. 14 shows an exploded side view of the track-runner and track of FIG. 13;

FIG. 15A is the embodiment of FIG. 1 configured to be able to accept a right-hand-saw, while FIG. 15B is the same embodiment of FIG. 1 except re-configured to be able to accept a left-hand-saw;

FIG. 16 is the configuration of FIG. 15B shown with a left-hand-saw attached;

FIG. 17 shows a perspective view of an arrangement where the saw blade of a right-hand saw is titled at an angle;

FIG. 18 shows a rear, end view of arrangement of FIG. 17; and

FIG. 19 shows the embodiment of FIG. 1 used hand-held by a user.

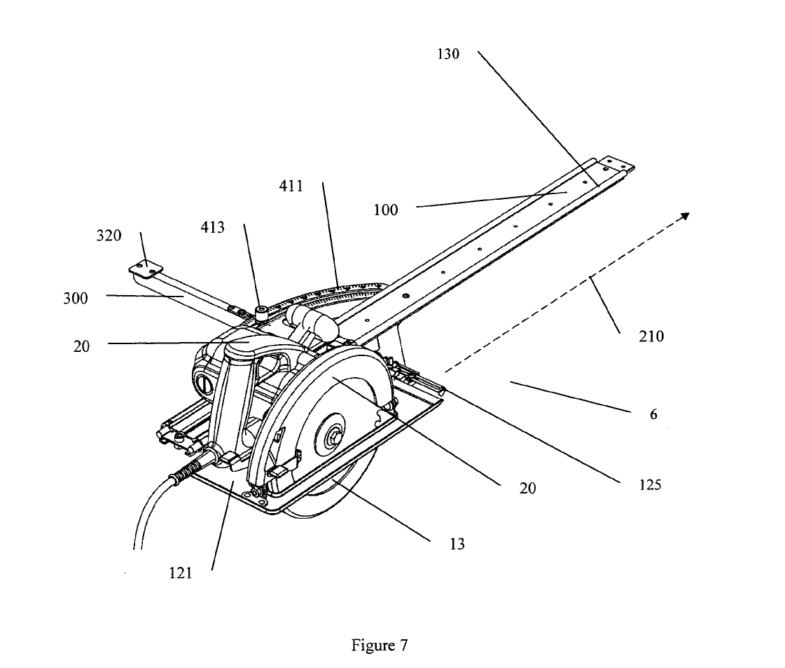

By way of background: hand-held circular power saws are designed to cut by being pushed forward, and never or highly unlikely by being pulled backwards. Hence, in the accompanying drawings, the forward direction in which a user 2, 2R, 2L pushes the saw 20, when making the cut, is represented by a uni-directional dotted arrow 210. Also, in right-handed circular saws, designed for use by right-handed users, the saw blade is usually positioned proximate the right-hand side of the saw housing (for instance, see the location of the saw blade 13 in FIG. 7). Hence, in the appended drawings, those which relate to right-hand saws, the arrow 210 emanates from around the right-hand side of the saw 20.

### DESCRIPTION OF EMBODIMENTS

### The Track

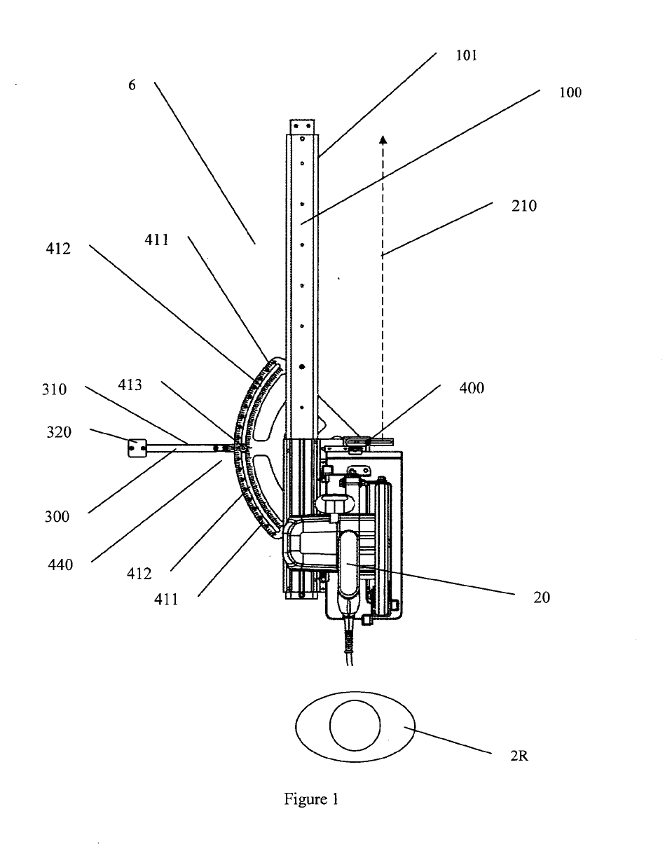

Referring to the accompanying drawings, FIG. 1 shows an embodiment of a portable saw guide 6 which includes a linear track 100. The track 100 enables a portable power saw 20 to reciprocate, and travel on and along the track 100 in a perfectly straight line.

In FIG. 1, the saw guide 6 is configured to accept a right-hand saw intended to be used by a right-handed user 2R. (The position of the user 2R in FIG. 1 is shown approximately, merely as an indication, and is not prescriptive).

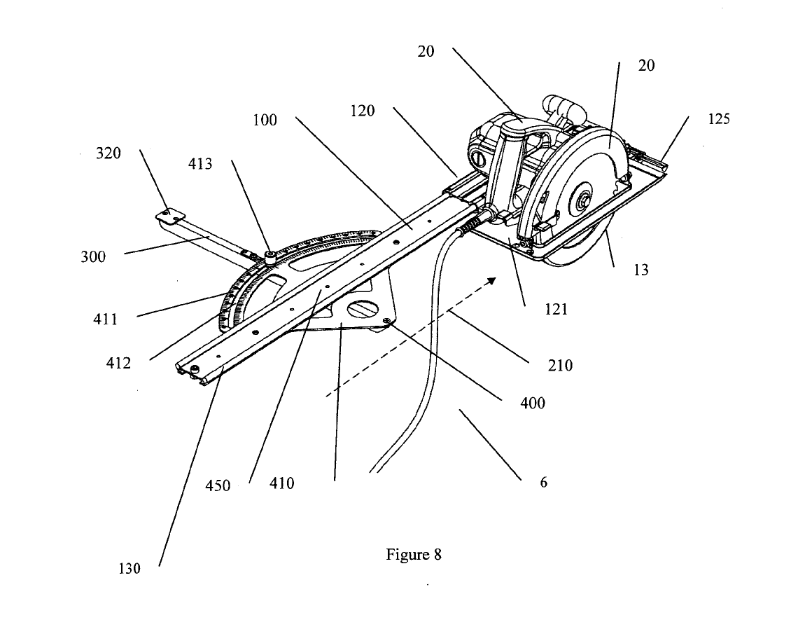

FIGS. 7 and 8 show perspective views of the embodiment of FIG. 1. FIG. 7 shows the embodiment with the saw 20 at the lower-end or start of the track 100 which, in use, would be closest to the user. FIG. 8 shows the same embodiment except with the saw having been pushed along the track to the other end or the finish.

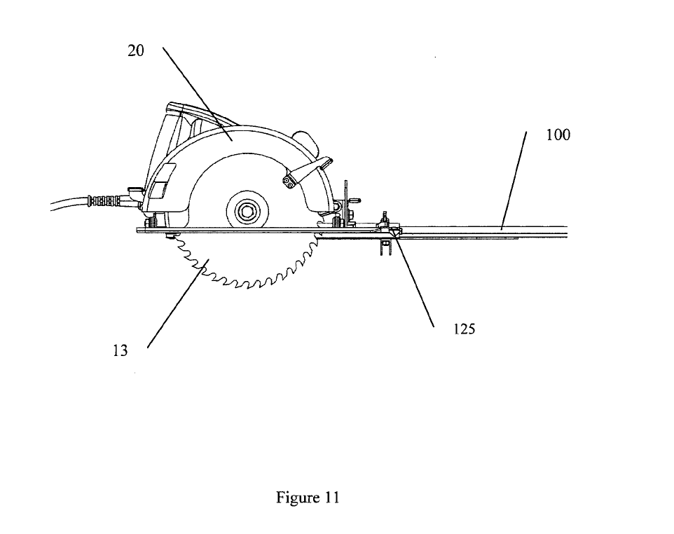

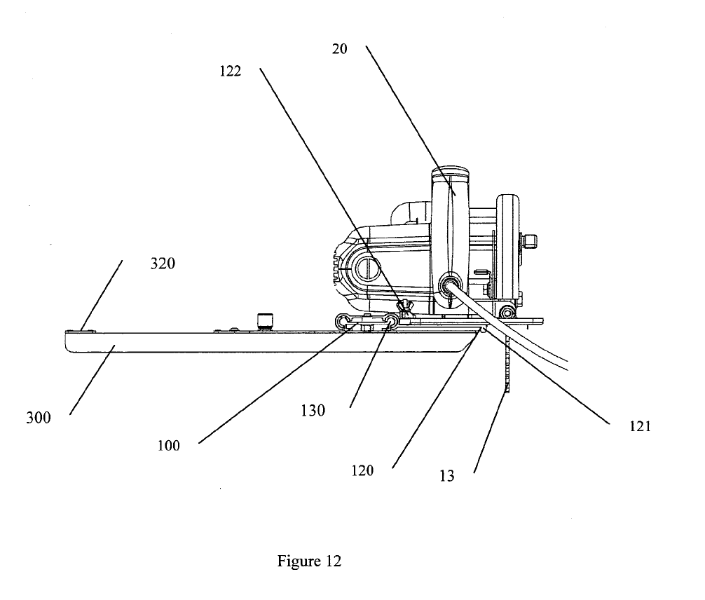

FIG. 11 shows a side view of the embodiment of FIGS. 1 and 7. FIG. 12 shows a front view of the embodiment of FIGS. 1 and 7.

### The Fence

In the embodiment of FIG. 1, the saw guide 6 includes portable positioning means in the form of a portable fence 300.

In FIG. 1, the fence 300 is an elongated flat piece that is adapted, in use, to be positioned motionless relative to, and held against, the object 1 to be cut.

The fence 300 has a flat face 310 that is able to sit flush with, and abut the object 1.

The user presses the flat front-face 310 of the fence 300 so that it abuts a flat edge of the object 1, and is held motionless relative to the object 1.

The user cuts the object by pushing the saw 20 on and along the track 100, and not by pulling the saw. The user begins the cut by pushing the saw 20 towards the fence 300, and as the object is cut, the user finishes the cut by pushing the saw, along the track 100, continuing to push the saw away from the fence.

The fence 300 can be positioned correctly by being held against the object 1 by the user's manual force. In the embodiment, since the saw is effectively connected to the track, at least part of the manual force, with which the user pushes the saw 20 forwards along the track 100 to cut the object, is also used to push and hold the fence 300 against the object 1. Thus, the forwards manual force, that pushes the saw, also serves a secondary purpose of keeping the fence 300 pressed against the object 1.

In the embodiment, since the user's manual force holds the fence in place, the fence 300 is able to be positioned and held against the object 1 without a mandatory requirement of a locking means, that would otherwise be needed to lock the fence 300 to the object 1.

The fence 300 may, however, be provided with an optional and not mandatory locking means adapted to lock the fence 300 to the object. In other words, the user need not use a locking means, although the apparatus can be provided with such a locking means to give the user the non-mandatory option.

In the exemplary embodiment, this avoidance of a mandatory locking means is a substantial advantage when the user has to make several hundreds angle-cuts per day. For professional carpenters, who can often make around 300 or more angle-cuts per day, the avoidance of 30-60 seconds per cut—which would otherwise be needed to tighten and un-tighten the locking means—can save several hours per day.

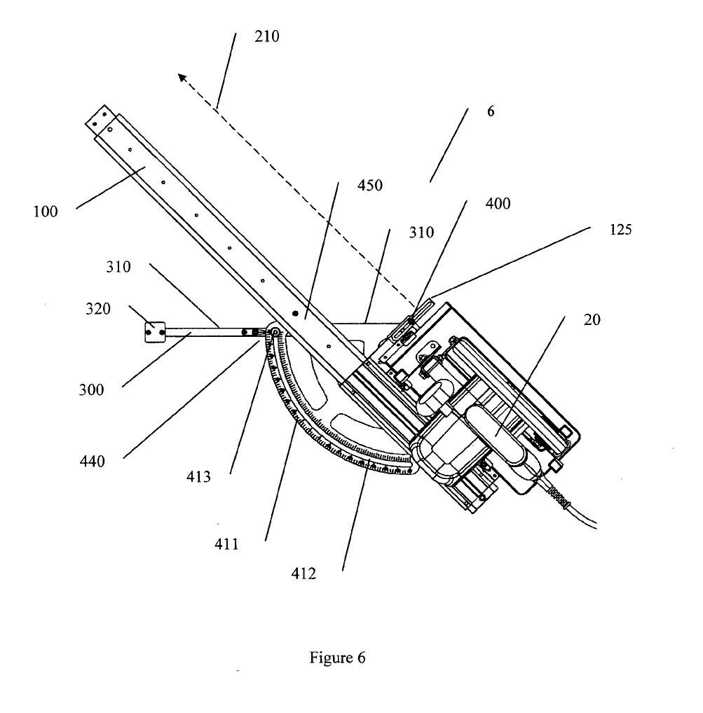

In FIGS. 1 and 7, one end of the fence 300 is provided with a stablilising tab 320. In use, this tab 320 sits on an edge of the object 1, and prevents the apparatus from rotating around the longitudinal axis of the track 100. Also, the under-surface of the track 100 (around the region of numeral 450 in FIG. 6) also performs the same function as the tab 320. Both these components, acting together, prevent the cutting-guidance apparatus from twisting around the longitudinal axis of the track 100.

The track 100 is pivotally connected to the fence 300. As can be appreciated from FIGS. 1, 5 and 6, this pivotal connection of the track 100 and fence 300 enables these components to be arranged at different angles relative to one another. The angle of the track 100, relative to the fence 300, effectively defines the angle at which the power saw 20 will cut the object 1.

The track 100 pivots relative to the fence 300 about a pivot point 400.

The pivot point is located on the fence 300.

The track 100 may be provided with an extension and retraction mechanism to selectively vary the length of the cutting-guide. For instance, the end of the track 100, which is furthest from the pivot point 400, can be adapted to have attached thereto another elongated track piece (not shown) to extend the overall length of the track.

Separation of the Pivot Point from the Track

In FIG. 1, the pivot point 400 is distanced from the leading edge 101 of the track 100. The pivot point 400 is separated from the leading edge 101 of the track 100.

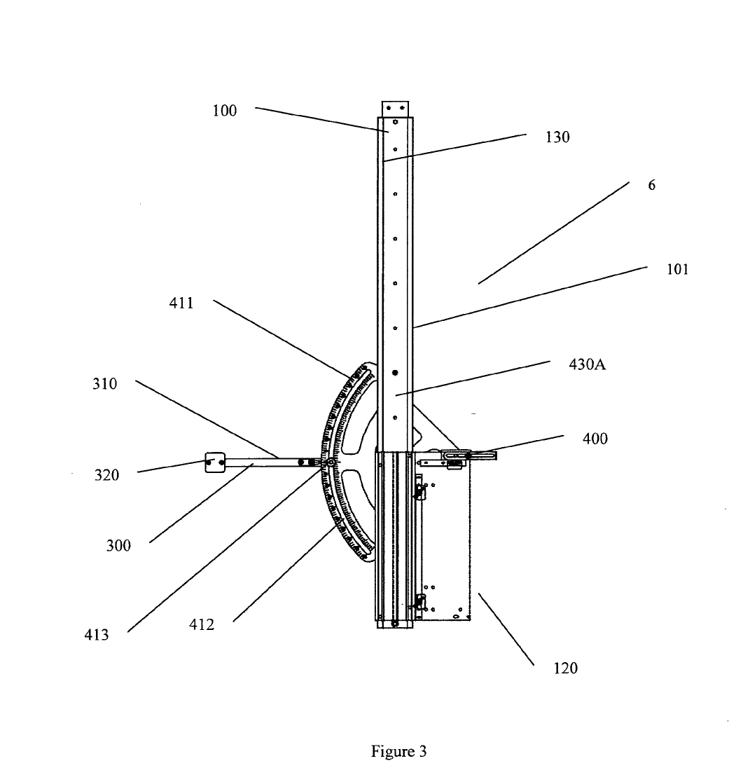

As defined above, the leading edge 101 is defined as being the edge that, in use, is closer to the saw blade of the saw 20. In FIG. 1 and FIG. 3, the leading edge 101 of the track 100 extends for the entire length of the track, from one end to the other.

The pivot point 400 is distanced from the leading edge 101 such that the entire leading edge 101 is able to pivot around and about the pivot point 400.

Specifically, the pivot point 400 is not located at an intersection of the track 100 and the fence 300.

An advantage of this displacement or distancing of the pivot point 400 from the leading edge 101 is seen in FIG. 6.

In FIG. 6, the track 100 is arranged at an acute angle, with the saw 20 positioned at the start of the track, before it begins its forwards cutting motion along the track. The saw 20 is able to be draw back sufficiently to position the saw 20 ready to perform the cut. Before performing the cut, there is a space between the circular blade 13 of the saw 20 and the object 1, so that the user can commence cutting by pushing the rotating blade 13 of the saw into the object 1.

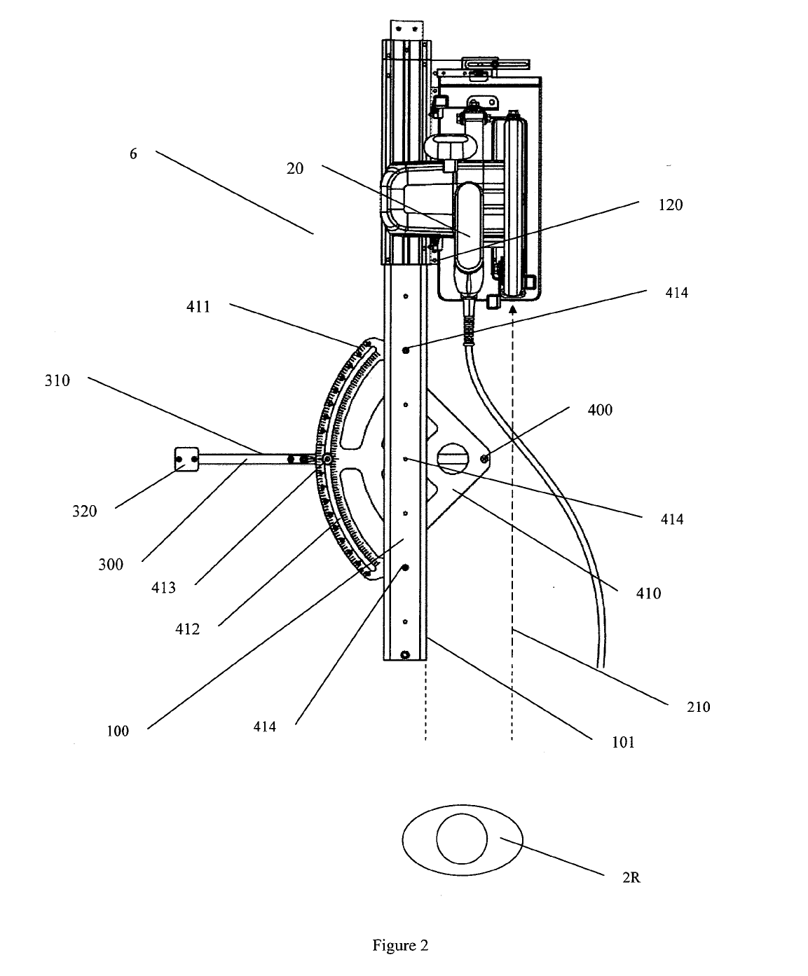

In the embodiment of FIG. 1, this distance is created by an extended arm 410 that is connected to the track 100. The arm 410 is best seen in FIG. 2 and FIG. 3.

In FIG. 6, before the saw 20 commences the cut, the blade of the saw is able to positioned as close as possible to the front of the object, while ensuring that the centre of gravity of the saw is as close as possible to pivot point 400 and the fence 300.

In FIG. 6, the saw is positioned as close as possible to the object, which is an ideal position for the user to commence pushing a power saw along the guide.

### Variation of the Selected Angle

In FIGS. 1, 5 and 6, the saw guide 6 is provided with a variable-angle mechanism that enables the user to orientate, and releasably fasten or lock the track 100 in a range of angles, relative to the fence 300.

In the embodiment, the variable-angle mechanism is in a form that includes a curved-support 411 which supports the track 100, while the track pivots through a range of angles, relative to the fence 300. In FIG. 1, the curved-support 411 resembles a curved protractor.

The curved-support 411 may be calibrated with markings of angle measurements, so that the user can select a precisely calibrated angle.

The combination of the track 100, the extended arm 410 and the curved support 411 altogether act as an integral unit. Therefore, this combination 100, 410, 411 rotates about the pivot point 400 as if it were one item.

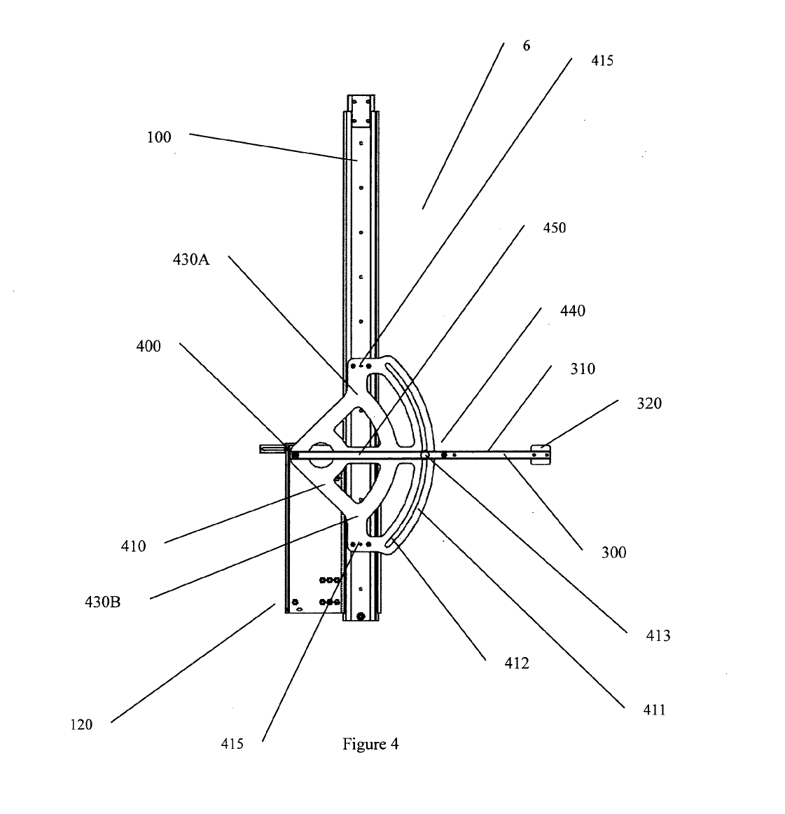

In the embodiment of FIG. 1, the track 100 is permanently supported by the combination of the extended arm 410 and curved support 411. The fixed support occurs at two locations 430A, 430B, as seen in FIG. 3 and FIG. 4. At these two locations 430A, 430B, the track 100 is fixed to the arm 410 and the curved support 411.

Therefore, the rotational movement of the arm 410 and support 411, about the pivot point 400, effectively enables the track 100 to rotate around the pivot point 400. Thus, the user is able to orientate the track 100 at a selected angle relative to the fence 300, so that the object 1 can be cut at this angle selected by the user.

The curved support 411 is supported by a section of the fence 300 at a region 440 where the curved support 411 of the protractor intersects the fence. Here, in this region 440, there is no permanent connection between the support 411 and the fence 300, since the curved support is adapted to rotate around the pivot point 400. At this region 440, different portions of the curved support 411 will be supported by the fence 300, depending on the selected angle. Thus, the curved support 411 merely rests on the fence 300.

In order to guide the circular motion of the curved support 411, the curved support 411 is provided with a curved slit 412. The C-shaped curved slit 412 is located along a central region of the C-shaped curved support 411. The slit 412 follows the C-shaped curvature of the support 411.

An upstanding post 413 is located on an upper surface of the fence 300. Both the post 413, and the curved slit 412, each lie on a circumference of a notional circle defined with the pivot point 400 at the centre of the circle. The post 413 is fixed and motionless. As the track 100 pivots about the pivot point 400, the support 411 likewise pivots around the same pivot 400. The post 413 rides within the curved slit 412 to ensure smoothness of rotational movement of the arm 410 and curved support 411 about the pivot point 400.

The variable-angle mechanism includes a position-locking means to lock the track 100 in the selected angle. This locks the track 100 to the fence in the selected angle. In the embodiment, the locking of the track in the selected angle can occur at the location 440 where the curved support rests on the fence 300. The locking can also occur at the pivot point 400. Alternatively, the locking can occur at both these locations 440, 400. The locking can also occur at any point where the track 100, or its supporting structure 410, 411, meets the fence 300. In the embodiment, the position-locking means is in the form of screw-threaded nut and bolt which screws down to hold the track 100 and its support structure against the fence 300. Other modifications of the position-locking means can be used in other embodiments.

### Cutting-Tool Guide

In the embodiment of FIG. 1, the saw is indirectly connected to the track 100.

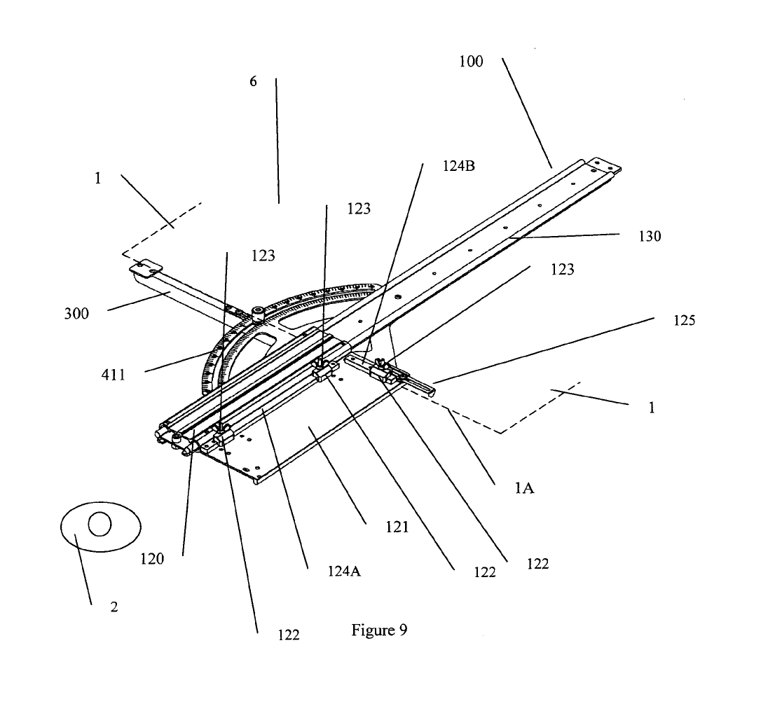

Compare FIGS. 7 and 9. FIG. 9 shows the embodiment of FIGS. 1 and 7 without a saw attached, and hence FIG. 9 reveals that the track 100 is provided with a cutting-tool support in the form of track-runner 120. The track-runner 120 reciprocates back and forth along the track 100.

The portable power saw 20 is able to be releasably attached to the track-runner 120.

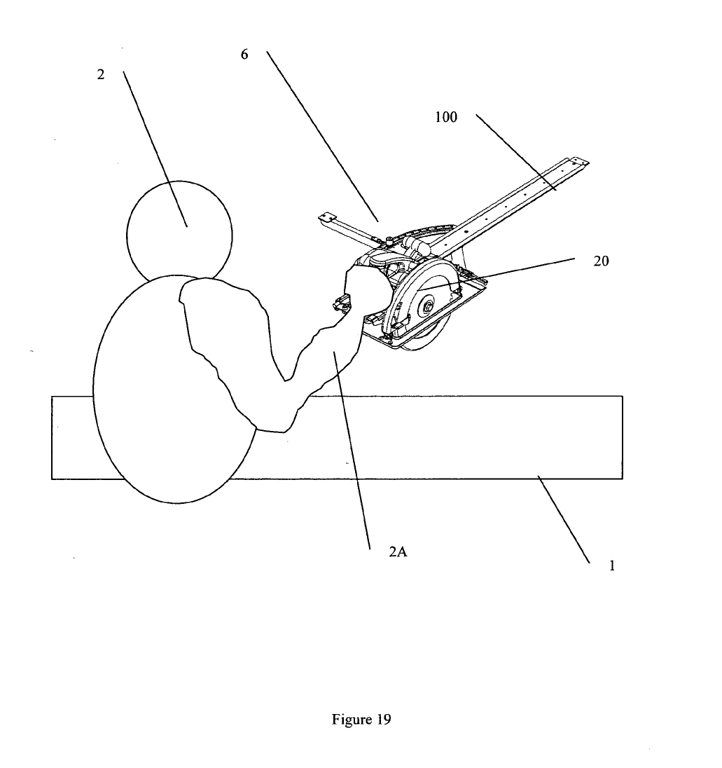

In FIG. 19, the saw 20 is attached to the track 100 via the track runner 120. The user 2 is able to lift, with one hand 2A, the entire portable cutting-guidance apparatus as one integral unit with the saw 20 attached.

Referring to FIG. 19, the user is able to lift the integral unit 6, 20 by using one hand to grasp the saw 20 in a manner in which the saw is designed to be handled normally as a portable tool. In so doing, the user can lift the entire assembly 6, 20 consisting of the saw 20 attached to the saw guide 6. For example, since the embodiment of the portable apparatus can be positioned by manual force alone, it enables the user to proceed from making one cut to the next, where the in-between time, from one cut to the next cut, may take a handful of seconds, typically around 5 to 10 seconds, or thereabouts. This allows a dramatic improvement in time-efficiency, because if the user were a professional carpenter making, say, 300 such cuts a day, the total time per day spent aligning the cuts is dramatically shorter, compared to the several lost hours if using saw guides which require time to set up the clamping before each cut is made. This dramatically short time, between performing one cut to the next cut, is impossible when using saw guides that are required to be bolted or fastened in place.

In order to make the linear cut in the object, the user first positions the flat face 310 of the fence 300 against the object 1 in correct alignment.

The manual force, that is used to keep the fence 300 pressed against the object, also includes the force with which the user pushes the saw forwards. In other words, as the user begins to push the saw forwards to make the cut, that same forwards motion is also serving to press the fence 300 against the object 1.

Therefore, the same forwards hand motion serves the dual purpose of keeping the fence 300 pressed against the object 1, as well as pushing the saw 20 forwards to make the cut.

In use, as in FIG. 19, the user 2 uses one hand 2A to lift the entire assembly 6, 20 (the saw attached to the saw guide). With a forwards motion, the user positions and presses the fence 300 against the object 1. Then, with the same forwards motion, he pushes the saw 20 forwards to make the cut. Following that, the user is able to again lift the entire assembly 6, 20 and re-position the saw for the next cut.

For this embodiment, the cycle, from one cut to the next cut, can take a matter of a handful of seconds, typically around 5 to 10 seconds, or thereabouts. This dramatically short time, between performing one cut to the next cut, is impossible when using saw guides that are required to be bolted or fastened in place, because the bolting or fastening takes up a lot of time. This very short cycle time, from cut to cut, is possible because the fence 300 of the embodiment is not required to be fastened to the object 1. This allows a dramatic increase in time-efficiency, because if the user were a professional carpenter making, say, 300 such cuts a day, the total time per day spent aligning the cuts is dramatically shorter, compared to the several lost hours if using saw guides that need to be bolted in place.

The user, if desired, can also use the embodiment of the saw guide by fastening and clamping the saw guide to the object 1 or to a support such as a table. In other words, the embodiment has the ability to be used hand-held, but the user can, at his discretion, choose to use the saw guide in a manner that involves clamping and fastening the saw guide 6 to a fixed object.

### Attachment Systems

In FIG. 9, to facilitate attachment of the saw 20, the track runner 120 has a side platform 121 which conforms to the shape of the underside of the housing of the saw 20. Part of the saw 20 is able to be supported by the side platform 121.

In FIG. 9, the track-runner 120 is provided with tool-attachment-means that enables a portable power cutting-tool to be attached thereto. The tool-attachment-means is located on the side platform 121 of the track-runner 120, since the saw is attached to the platform 121.

Most portable power saws on the market have a flat baseplate 23 which varies in thickness, or have a baseplate 23 with an upwardly turned lip 24 at the edge of the baseplate. The tool-attachment-means includes two clamping members 122. When the saw is positioned against the side platform 121, the clamping members 122 sandwich the saw base in position by tightening a locking screw 123, in a downward direction, thus applying pressure to lock the saw base in position.

The two clamping members 122 are supported on a long locking bar 124A which is releasably fastened onto the side platform 121. The long locking bar 124A, of the tool-attachment-means, is positioned on the side platform 121 in parallel to the longitudinal axis of the track 100. The tool-attachment-means also includes another clamping member 122 that is releasably fastened to a shorter locking bar 124B. This shorter locking bar 124B, of the tool-attachment-means, is releasably fastened onto the side platform 121, perpendicular to the longitudinal axis of the track 100. Embodiments of the invention are not limited to one particular configuration of tool-attachment-means, and many mechanical alternatives can be used to achieve the function of attaching the saw or cutting tool to the side platform 121.

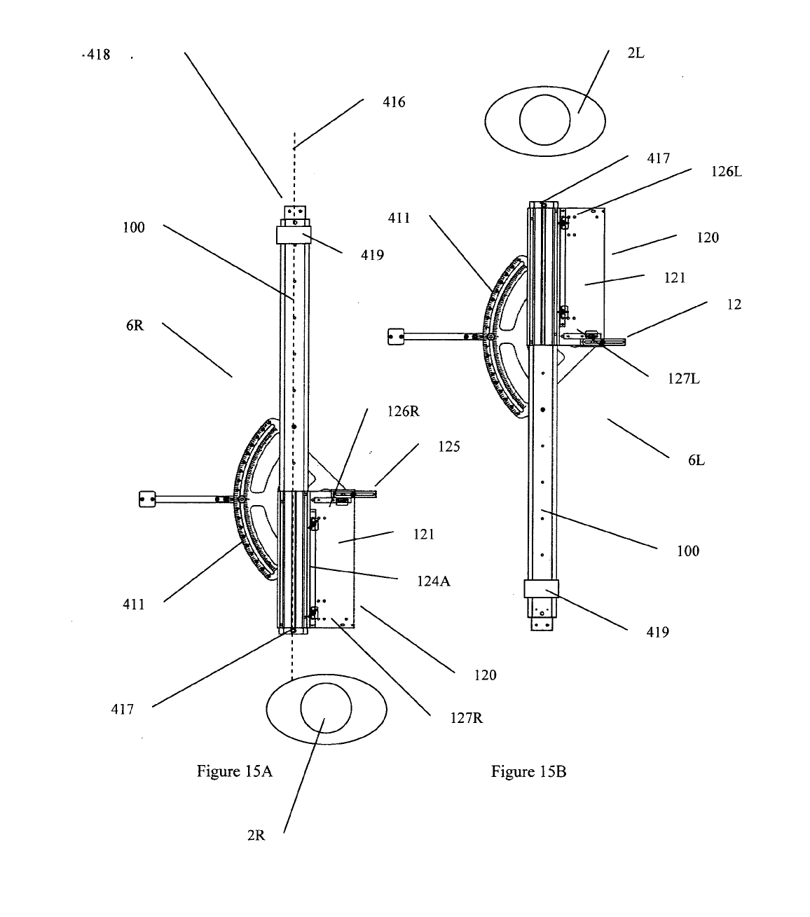

In order to optimally grip the baseplate of typical portable saws found in the market, as shown in FIGS. 9 and 15A, the long locking bar 124A is located on the side platform, arranged in a location that, in use, will be closer to the user. Also, as shown in FIGS. 9 and 15A, the short locking bar 124B is located on the side platform, arranged in a location that, in use, will be furthest away from the user 2. This enables the clamping member 122 of the short locking bar 124B to lock onto the front edge of the saw baseplate. (In FIG. 9, the approximate location of the user 2 is indicated by a head and shoulders symbol 2).

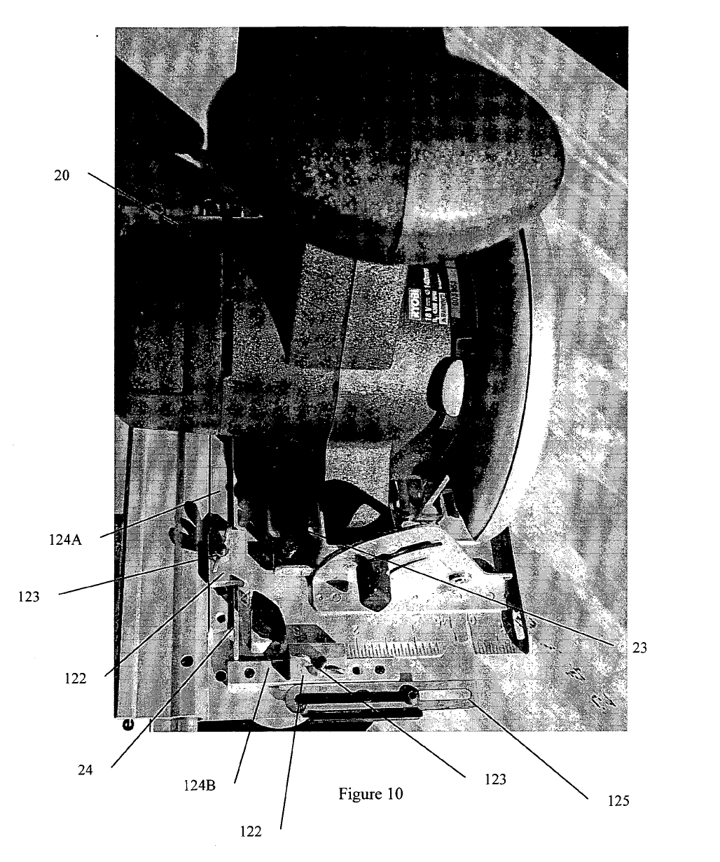

FIG. 10 shows how the baseplate 23 of a saw is fastened to the upper surface of the side platform 121. The clamping member 122, that is fastened to the long locking bar 124A, is used to hook over the upwardly turned lip 24 of the saw's baseplate 23. Also, the other clamping member 122, that is fastened to the short locking bar 124B, is used to press down on the edge of the edge of the baseplate 23. In FIG. 10, there is another clamping member 122 that is hidden by the saw, but visible in the other diagrams such as FIG. 9. Altogether, the combination of all the clamping members 122 fasten and hold the saw 20 in place on top of the side platform 121.

In use, when the saw 20 is firmly clamped to the track-runner 120, the power saw 20 can be pushed forwards along the track 100 to achieve a perfectly straight cut of the object 1, and to also moved backwards to reposition the saw for the next cut.

The saw 20 is thus removably attached to the track 100, and can be removed by releasing the releasable clamping mechanisms 122, 123.

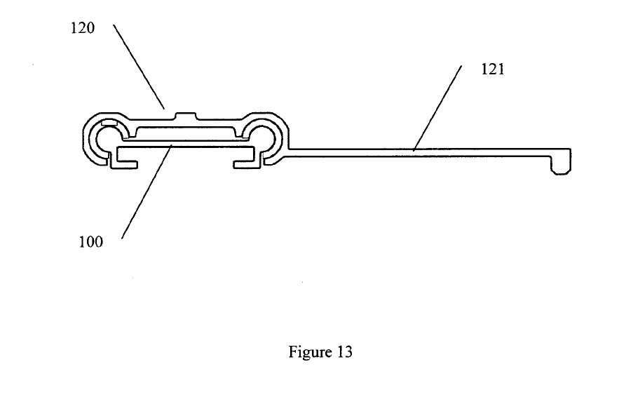

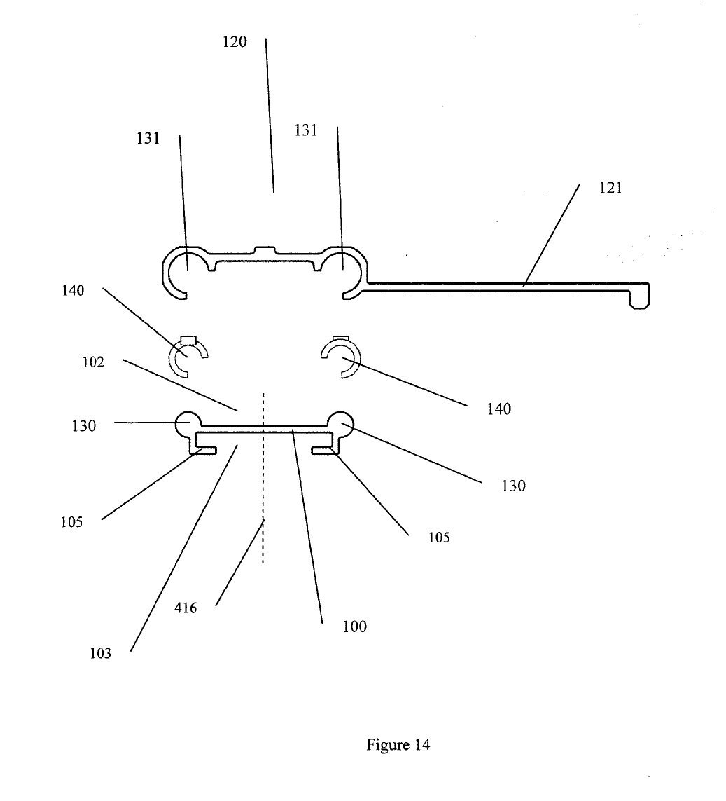

The track 100 include a glide mechanism that allows the track-runner 120 to travel smoothly along the cutting-guide. FIG. 13 shows a cross-sectional front view of the track 100 and the track-runner 120. FIG. 14 is an exploded view of FIG. 13, showing the components in greater detail.

In FIGS. 13 and 14, the glide mechanism includes one or more linear ribs 130 on the upper surface of the track 100. Corresponding grooves or channels 131 are located on the under-surface of the track-runner 120. The grooves or channels 131 are able to ride or glide on the corresponding ribs 130. The ribs 130 and grooves 131 extended along substantially the entire length of the track 100.

The fit of the rounded-ribs 130 within the cylindrical grooves 131 means that, once the linear ribs 130 are running within the elongated grooves 131, the ribs can only move forwards and backwards along the groove.

In other words, the ribs cannot move upwards or downwards. Thus, the user need not apply a sideways force 22 to maintain the saw against the track 100. Also, the shape of the rounded ribs 130 within the grooves also means that the ribs cannot move up and down inside the groove. Thus, the user need not apply a sideways downwards force to maintain the saw on top of the track 100.

In other embodiments, a kinematic inversion can involve the glide mechanism including one or more linear channels (not shown) in the surface of the track 100. Corresponding ribs are located on the under-surface of the track-runner 120. The ribs are able to glide on the corresponding grooves.

In the cross-sectional FIG. 14, the linear ribs 130 are provided with self-lubricating bearings or bearing-guides 140 which reduce the friction between the inner surfaces of the ribs 130 and grooves 131. These bearings may be made of neoprene, polyurethane or other suitable material, or, for example, of the nature of linear roller bearings, for reducing friction of moving mechanical parts.

The invention is not limited to a particular design appearance of the track 100. The illustrated embodiment of the track and clamping device represents merely an example.

In the present embodiment, the track-runner 120 ensures that the power saw 20 moves perfectly linearly along the track 100. Hence, the user does not need to exert a sideways force 22 to maintain the saw 20 sideways up against the linear guide to keep it aligned with the track 100.

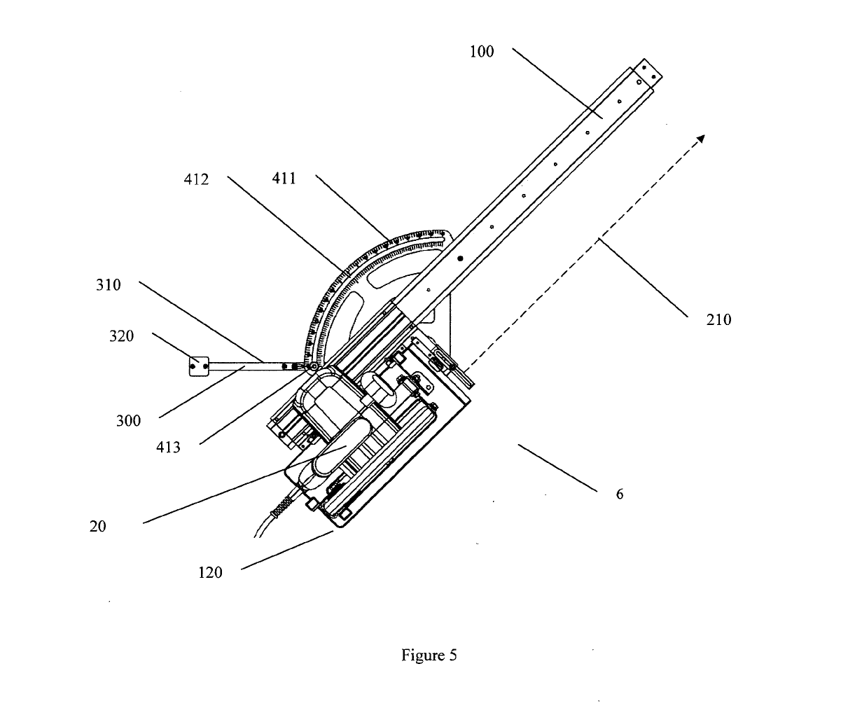

For the embodiment, the only force the user exerts need to exert is a forwards force in line with the longitudinal axis of the track 100. For the embodiment, since the user does not exert a sideways 22 force on the saw, it is one factor that avoids the need for a locking or clamping mechanism to lock the fence 300 to the object 1. This is because, in FIG. 1 as well as in FIGS. 5 and 6, the user's force which pushes the saw forwards along the track, is sufficient to hold the fence 300 against the object 1.

The use of a cutting-tool support in the embodiment keeps the saw travelling on a perfectly linear path along the track 100, and thus prevents the circular saw from veering off course due to forces that comes from the rotating blade 13 of the saw 20.

Location of the Pivot Point with Respect to the Line of Cut

FIG. 12 is a front-view of the saw guide 6. The track 100 and the track-runner 120 are positioned above the fence 300, such that the track-runner 120 is able to pass across the fence 300 without hindrance, as it travels along the track.

In hand-held power saws, a circular blade 13 usually lies in a plane that is located to one side of the saw housing. (Hence in the drawings of the embodiment, the line of cut of the circular blade 13 is shown as a dotted-arrow 210).

When the power saw 20 is attached to the track-runner 120, the line of cut 210 preferably passes as close as practically possible to the pivot point 400. This is achieved because the saw blade 13 is distanced from the leading edge 101 of the track 100 by a measure. This measure is not equal to, but is substantially equivalent to the distance between the pivot point 400 and the same leading edge 101 of the cutting-guide 100.

For smaller saws, the line of cut 210 passes closer to the pivot point 400, whereas for larger saws the line of cut 210 may be slightly further away from the pivot point 400, however, in all cases, the line of cut 210 is preferably as close as practically possible to the pivot point 400, given the size of the saw.

It is advantageous for the line of cut 210 to be as close as possible to the pivot point 400. This is because the pivot point defines the point of reference for determining the angle between the track 100 and the fence 300. The selected angle is actually defined as the angle between, i) a line that passes through the fence and the pivot point, and ii) a line which passes through the pivot point and which is parallel to the track. Thus, when the user aligns the selected angle, the intention is to create a cut that is as close as possible to the pivot point.

If the line of cut did not pass substantially close to the pivot point 400, then a problem would be that, whenever the user changes the selected angle, there will be a considerable change in the point at which the line of cut crosses the object l to be cut.

In FIGS. 1, 5 and 6, the point at which the line of cut crosses the object 1 consistently remains substantially close to or around the pivot point 400, as close as is practically possible.

By having the line of cut 210 as close as practically possible to the pivot point 400, depending on the size of the saw, it means that the user can adjust the selected angle, without significantly altering the point at which the object 1 is cut. For instance, when considering FIGS. 1, 5 and 6, it is appreciated that, irrespective of the selected angle, the line of cut 21 always passes substantially close to the pivot point or pivotal axis 400. In other words, when the user changes the selected angle, the user does not need to substantially re-position the fence 300 with respect to the object. A few seconds saved, by not having to substantially re-adjust the position, when the user has to make several hundred cuts per day, can add up to a considerable saving of time.

In the embodiments, the intention is for the line of cut 210 to be as close as possible to the pivot point, but in the practical embodiment in the series of drawings in FIGS. 3 and 4, the measure is as close as practically possible to the pivot point 400, depending on what size of saw is installed. This is closer than would be the case if the pivot point were to be on the track 100. This is because the track-runner 120 is shaped to accept a range of typical power saws 20 with different sized blade, such as 6¼ inch, 7¼ inch, 8.25 inch, and 9.25 inch diameter blades. As the size of the saw blades increases, the size of the housing of the saw increases slightly, which causes the line of cut 210 to be located progressively further away from the pivot point 400 by a slight amount. The line of cut is closest to the pivot point when smaller saws are used.

In practice, however, even for the largest hand-held saws currently available on the market, it is found that the gap between the pivot point and the line of cut is not significant, which is considered an acceptable range. In practice, it does not significantly detract from the performance of the accessory apparatus.

Nevertheless, the larger hand-held saws, that would yield a larger gap, tend to be less commonly used by tradesmen. Hence, it is found that the majority of commonly used saws would have very small gaps between the line of cut and the pivot point.

The position of the line of cut 21 varies, ever so slightly, depending on the size of the saw 20 produced by different manufacturers. (It so happens that this variation between different manufacturers is very similar).

From FIG. 7, it can be appreciated that the user cannot actually see the actual saw blade 13 when handling the saw in the normal position. Therefore, the front edge of the track-runner 120 may be provided with an adjustable blade marker 125. Thus, the blade marker is adjustable to suit the range of different sizes of cutting blades available on the market.

The blade marker 125 can be adjusted by being shift laterally along the leading edge of the track-runner 120. The user makes a test cut on a scrap object 1, and adjust the marker 125 to align with the line of cut produced by the particular saw 20. The blade marker 125 helps the user know or predict where the cut will be produced.

In the present embodiments, the saw guide and its components are made mostly of aluminium, which provides sufficient strength and stiffness without excessive weight. However, other materials may be used, such as steel, and even lighter materials such as rigid plastic and composite materials such as fibreglass or carbon fibre.

In other embodiments, the appearance of the fence 300 can be modified, provided it fulfils the function of a positioning-means. For instance, rather than having a flat front face, a modified fence may have a series of projections of equal size that confront the front surface of the object 1.

Comparing the fin 410 of the first embodiment, with the functionally-similar extended arm 410 and curved support 411 in the embodiment, it is evident there are numerous variations for extending the pivot point 400 away from an edge of the track 100.

### Ability to Use Right and Left Hand Saws

In the power tool industry, when looking at a portable saw held in one's hand, a portable right-hand-saw is defined as one in which the blade is the right hand side of the motor. This is a configuration that right-handed people find most comfortable to use. A right hand user will grasp a right-hand-saw with his right hand.

In contrast, a portable left-hand-saw is defined as one in which, when looking at a portable saw held in one's hand, the blade is to the left hand side of the motor. Generally, left-handed persons tend to find it most comfortable to use a left-handed saw, grasping it with the left hand.

In the drawing of FIG. 1, the embodiment is shown with a right-hand saw, and the blade is to the right side of the motor.

In the prior art, there is a problem that saw guides are configured for right-hand saws. This means that a left-handed user, who uses such a right-hand-friendly saw guide, is forced to use a right-hand saw and thus use it with his right hand, contrary to his natural preference for left-handed use.

To solve this problem, the embodiment of the present invention is able to be adapted for use with both right-hand-saws and left-hand-saws.

In the embodiment of FIG. 15A, the saw guide 6 is configured to accept a right-hand-saw.

In the embodiment, the cutting-tool support is provided with right-and-left-configuration-means that enables the cutting-tool support to be configured and arranged to have both a right-hand and left-hand portable cutting-tool attached thereto as alternatives.

For the sake of clarify, this does not mean that the saw guide 6 would carry, at the same time, two saws. Rather, it means that the user is able to decide whether to configure the same saw guide to allow attachment of either a right-hand-saw or left-hand-saw.

FIG. 15A shows the saw guide 6R (the suffix R indicates right-hand configuration) with its track-runner 120 configured to accept a right-hand-saw.

In comparison, FIG. 15B shows the same saw guide 6L (the suffix L indicates left-hand configuration, although it is the same apparatus) with its same track-runner 120 configured alternatively to accept a left-hand-saw.

In other words, the same saw guide 6, 6R, 6L can be configured to accept either a right-hand-saw or a left-hand-saw in the alternative, or optionally a cutting-router.

As mentioned, the track-runner or carriage 120 reciprocates backwards and forwards along the track 100.

The process of re-configuring the saw guide 6 between a right configuration (FIG. 15A) and left configuration (FIG. 15B) includes steps described as follows:

The saw guide has right-saw-and-left-saw-configuration-means that includes both right and left configuration-means for the following:

the cutting-tool support and the tool-attachment-means therefor; and

the variable-angle mechanism;

such that the saw guide 6 is able to be alternatively configured or re-configured between either a first arrangement adapted for use with a right-hand-saw, and a second-arrangement adapted for use with a left-hand-saw.

In the embodiment, the right-saw-and-left-saw-configuration-means for the curved-support 411 includes fastening means for releasably fastening the curved-support 411 to the track 100 at a location proximate one end thereof, and further fastening means for releasably fastening the curved-support 411, as an alternative, to the track 100 at another location that is proximate the other end of track.

The curved-support 411, which resembles a curved protractor, is unfastened from its position, proximate one end of the track 100, as shown in FIG. 15A, and is then shifted to another location that is proximate the other end of the same track and fastened, as shown in FIG. 15B.

The curved-support is provided with fastening means in the form of releasable locking screws 414 that are used to lock the curved-support 411 at the desired end of the track 100. The three locking screws 414 are seen in FIG. 2. The fastening means also includes holes 415. The screws 414 engage with corresponding holes 415 in the curved-support 411 and with a hole (not shown) on the upper surface of the fence 300.

In FIG. 14, the track-runner 120 and its side-platform carriage 121 reciprocate on the upper side 102 of the track, riding on the pair of parallel linear ribs 130. The curved-support device 411 is able to reciprocate in an open, linear slot in the undersurface 103 of the track 100. The slot is defined by a pair of parallel, inward-facing ledges 105 that each extend along the length of the track 100. As shown in FIGS. 15A and 15B, the curved-support 411 can be unfastened, and pushed from one end of the track 100 to the other, because the curved-support 411 engages with the linear slot defined by the under-surface ledges 105.

In FIG. 15A, at the end of the track which, in use, is closest to the user, there is provided a stop 417 that prevents the track-runner 120 from totally sliding off the track. The stop 417 can be in the form of a screw, plate or any item that can block the track-runner 120 from sliding off the track. When converting from a right-hand to a left-hand configuration, the stop 417 can be unfastened from one end, as shown in FIG. 15A, and transferred to the opposite end of the track, as shown in FIG. 15B.

In the embodiment, there is also a larger adjustable stop 419 that can be positioned at the end 418 furthest away from the user, and during the conversion, the position of this optional end-stop 419 can also be swapped from one end to the other. The adjustable stop 419 has a cross-section that enables it to glide along the track 100, and has a cross-section similar to the track-runner 120 shown in FIG. 14, except that the adjustable stop does not have the side-platform 121. The adjustable stop 419 is held in place by a screw which can be loosened to unlock and release the stop 419. The adjustable stop 419 can be used optionally when the user requires the cut of the saw to stop at a precise location.

On the track-runner 120, the blade marker 125 is unfastened and shifted from one end of the track-runner platform 120 (FIG. 15A) to the other end (FIG. 15B). This to ensure that, in either the right or left configuration, the blade marker 125 is always positioned at the leading edge of the side-platform 121. The leading edge is the front edge of the side-platform that leads the way when the saw is pushed forward to make the cut. Hence, the leading edge of the side-platform 121, in either right or left configuration, is the edge which, in use, is furthest from the user.

In the conversion of the embodiment from a right-hand configuration to a left-hand configuration, the long locking bar 124A is released from its original position (see FIG. 15A) and re-positioned in the location (see FIG. 15B) that, in use, will be closer to the user who is a left-handed user. In effect, this re-positioning transfers the long locking bar 124A to a location that, for the left-handed user 2L, is akin to what a right-handed 2R user would experience in its original location. In either the left or right configuration, the longitudinal axis of the long locking bar 124A is always parallel to the longitudinal axis of the track 100.

Also, in the conversion, the short locking bar 124B, together with the blade marker 125, are re-located to the other edge of the side-platform 121 in order to be located in a position that, in use, will be furthest away from the left-handed user 2L. This to ensure that, in either the right or left configuration, the short locking bar 124B is always positioned at the leading edge of the side-platform 121. In either the left or right configuration, the longitudinal axis of the short locking bar 124B is always perpendicular to the longitudinal axis of the track 100. In effect, this re-positioning transfers the short locking bar 124B to a location that, for the left-handed user 2L, is akin to what a right-handed 2R user would experience in its original location.

In FIG. 15A, the side-platform 121 in the right-hand-configuration has a leading edge 126R, and this same leading edge 126R, after the conversion, becomes the trailing edge 126L in the left-hand-configuration in FIG. 15B.

Likewise, in FIG. 15A, the side-platform 121 in the right-hand-configuration has a trailing edge 127R, and this same trailing edge 127R, after the conversion, becomes the leading edge 127L in the left-hand-configuration in FIG. 15B.

In the embodiment, in FIG. 14 and FIG. 15A, the track 100 is symmetrical about its longitudinal axis 416 in order that the saw guide 6 functions in the same manner, from the user's perspective, irrespective of whether the guide 6 is configured to accept a right-hand-saw (FIG. 15A) or left-hand-saw (FIG. 15B).

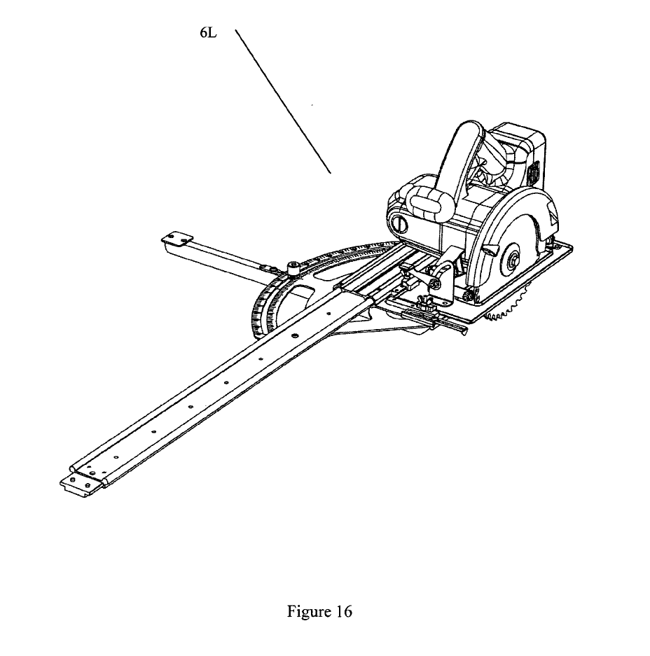

FIG. 16 shows a left-hand-saw attached to the saw guide 6L (the suffix L indicate that the same saw guide 6 is configured in a left-hand configuration, but it is understood that reference numerals 6 and 6L refer to the same saw guide). As defined, in the left-hand saw, the saw is to the left hand side of the motor, as seen by the user when holding the saw.

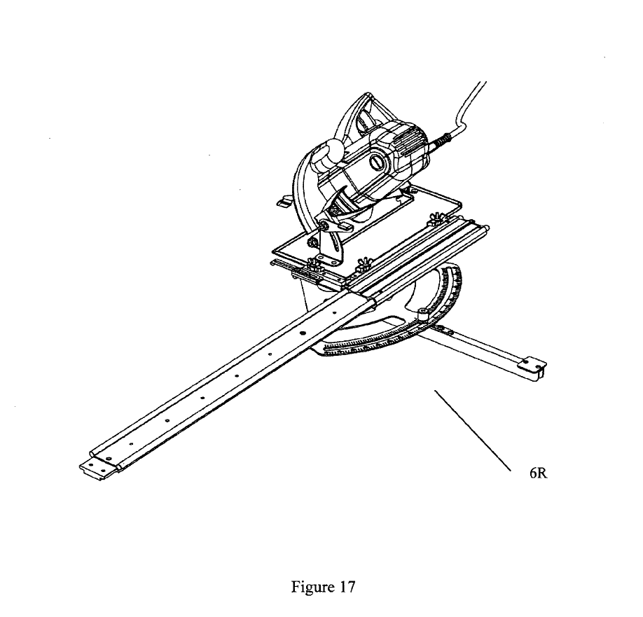

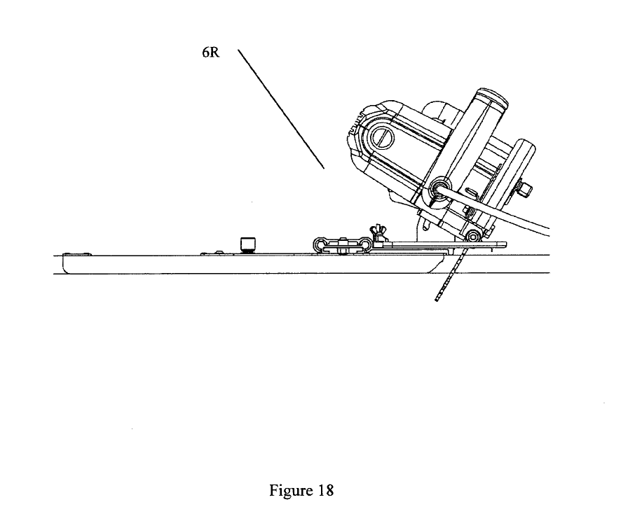

FIG. 17 shows a right-hand-saw attached to the saw guide. The combination is provided with saw-tilt-means that enables the saw blade to be tilted such that the saw blade forms is substantially non-perpendicular with respect to the plane of the support plate 121. FIG. 18 shows a right-hand-saw which, in combination with the saw guide 6R, enables the saw blade to be tilted such that the plane of the saw blade is substantially non-perpendicular with respect to the support plane of the support plate. The support plane of the support plate 121 is the plane that is defined by the large flat surface of the plate 121. The saw-tilt feature is available for both the right and left hand configurations.

The present invention, in its broadest aspect, is limited to the field of portable power-tools which are hand-held when being used. Specifically, the present invention excludes power tools which are so heavy as to be regarded as non-portable, and which ordinarily have to be placed on a bench or other work-surface when being used. Thus, embodiments of the invention can be used as an accessory for portable hand-held power tools. In this specification, the word portable is construed as it is used in the power tool production trade, and particularly how the word is understood by end-users of such portable power tools. In the trade, a portable cutting tool is one that is designed and intended to be used as a hand-held tool, day in day out, in ordinary usage. For instance, a 100 kg powered saw machine might conceivably be lifted, for a few moments, by a person who is extremely strong, and may fall within a published dictionary definition of something that is portable, i.e. lift-able, however, this mere ability to be lifted is not what is intended in this specification by the definition of a portable power cutting-tool. Rather, the term “portable cutting tool”, as used by tradesmen and craftsmen, who use such tools, refers to a power tool that is readily hand-held, and is designed and intended to be used for cutting while the tool is being held by hand.

In the specification and appended claims, it is understood that the saw or other cutting tool is not part of the invention, and that a range of commercially-available saws and cutting tools can be used for attachment to embodiments of the apparatus of the present invention.

Although the embodiments have been described in the context of hand-held circular power saws, other modifications may be used with other hand-held cutting tools, such as a portable jig-saw and routers. In the embodiment, the saw guide 6, in either the left or right hand configuration, is able to have attached a portable power cutting-tool in the form of a router.

The embodiments have been advanced by way of example only, and modifications are possible within the scope of the invention as defined by the appended claims.

1. A portable cutting-guidance apparatus adapted to be used with a portable power cutting-tool that has a cutting implement to enable the cutting-tool to cut an object at a variably selected angle, including:
portable positioning means adapted, in use, to be positioned motionless against an object to be cut by a portable power cutting-tool; and
a linear cutting-guide adapted to enable the portable power cutting-tool to travel on and along the cutting-guide in a straight line, the cutting-guide being provided with a cutting-tool support adapted to travel and reciprocate along the cutting-guide, and adapted to have the portable cutting-tool attachable thereto,
the cutting-tool support having tool-attachment-means that allows the portable power cutting-tool to be removably attachable thereto, such that the cutting-tool support, when the portable power cutting-tool is so attached, is able to reciprocate back and forth along the cutting-guide,
the cutting-guide being pivotally connected to the positioning means about a pivot point by a variable-angle mechanism that is adapted to adjustably fasten the cutting-guide to the positioning means at a variably selected angle relative to one another such that, in use, the portable power cutting-tool is able to travel on and along the cutting-guide to cut the object in a straight line at the variably selected angle;
wherein the apparatus is able to be configured and arranged to have as alternatives either a right-hand and left-hand portable power cutting-tool attached to the cutting-tool support for use with the apparatus.

2. An apparatus of claim 1 wherein the cutting-tool support is provided with right-saw-and-left-saw-configuration-means that enables the cutting-tool support to be configured and arranged to have as alternatives either a right-hand and left-hand portable power cutting-tool attached to the cutting-tool support.

3. An apparatus of claim 2 wherein the right-saw-and-left-saw-configuration-means includes both right and left configuration-means for the following:
the cutting-tool support and the tool-attachment-means therefor; and
the variable-angle mechanism;
such that the portable cutting-guidance apparatus is able to be alternatively configured or re-configured between either a first arrangement adapted for use with a right-hand-saw and a second-arrangement adapted for use with a left-hand-saw.

4. An apparatus of claim 3 wherein the right-saw-and-left-saw-configuration-means for the tool-attachment-means includes clamping members for attaching either the right-hand or left-hand saw to the cutting-tool support, the clamping members alternatively attachable to the cutting-tool support in either the first or second arrangements.

5. An apparatus of claim 3 wherein the right-saw-and-left-saw-configuration-means for the variable-angle mechanism includes fastening means for releasably fastening the variable-angle mechanism to the cutting-guide at a location proximate one end thereof, and further fastening means for releasably fastening the variable-angle mechanism as an alternative to the cutting-guide at another location that is proximate the other end of cutting-guide.

6. An apparatus of claim 3 wherein the cutting-tool support in the right-hand arrangement has a leading edge and a trailing edge, whereupon, after the conversion, the leading edge in the right-hand arrangement becomes the trailing edge in the left-hand arrangement.

7. An apparatus of any one of the preceding claims wherein the linear cutting-guide is symmetrical about its longitudinal axis.

8. An apparatus of any one of the preceding claims wherein the portable positioning means including an abutment surface adapted, in use, to abut the object so as to position the positioning means motionless relative to the object, and the positioning means adapted, in use, to be positioned and held against the object by manual force of the user, the manual force including force with which the user pushes the portable power cutting-tool forwards along the cutting-guide to cut the object,
wherein, in use, when the cutting-tool is attached to the linear saw guide, the user is able to lift and operate with one hand the entire portable cutting-guidance apparatus as one integral unit with the cutting-tool attached,
wherein the linear cutting-guide has a leading edge which, in use, is closest to the cutting implement,
wherein the pivot point is distanced from the leading edge of the cutting-guide such that the entire leading edge is able to pivot around and about the pivot point,
wherein, when the portable cutting-tool is attached to the cutting-tool support, the cutting implement is distanced from the leading edge of the cutting-guide by a measure that exceeds said distance between the pivot point and the leading edge of the cutting-guide such that the cutting implement has a line of cut that passes as close as practically possible to the pivot point in order that, when the positioning means is held against the object by the manual force of the user so as to allow cutting of the object at a certain point, the apparatus enables the user to adjust the selected angle of the apparatus without significantly altering said point at which the object is cut,
wherein the positioning means is adapted, in use, to be positioned and held against the object without requiring a locking means that would otherwise lock the positioning means to the object,
wherein the user is able to lift the integral unit by grasping the cutting-tool in a manner in which the cutting-tool is designed to be handled as a portable tool, and
wherein the power cutting-tool is a saw, and wherein the blade of the saw is as close as practically possible to the pivot point depending on the size of the housing of the saw.

9. An apparatus of any one of the preceding claims wherein the pivot point is located on the positioning means, and wherein the pivot point is distanced from an intersection of the cutting-guide and the positioning means.

10. An apparatus of any one of the preceding claims wherein the variable-angle mechanism includes a curved-support which supports the cutting-guide as the cutting-guide pivots relative to the positioning means through a range of selectable angles.

11. A method of configuring a portable cutting-guidance apparatus which is adapted to be used with a portable power cutting-tool that has a cutting implement to cut an object at a variably selected angle, and in which the apparatus includes:
portable positioning means adapted, in use, to be positioned motionless against an object to be cut by a portable power cutting-tool; and
a linear cutting-guide adapted to enable the portable power cutting-tool to travel on and along the cutting-guide in a straight line, the cutting-guide being provided with a cutting-tool support adapted to travel and reciprocate along the cutting-guide, and adapted to have the portable cutting-tool attachable thereto,
the cutting-tool support having tool-attachment-means that allows the portable power cutting-tool to be removably attachable thereto, such that the cutting-tool support, when the portable power cutting-tool is so attached, is able to reciprocate back and forth along the cutting-guide,
the cutting-guide being pivotally connected to the positioning means about a pivot point by a variable-angle mechanism that is adapted to adjustably fasten the cutting-guide to the positioning means at a variably selected angle relative to one another such that, in use, the portable power cutting-tool is able to travel on and along the cutting-guide to cut the object in a straight line at the variably selected angle;
the method includes configuring and arranging the apparatus in order to attach, as an alternative, either a right-hand and left-hand portable power cutting-tool to the cutting-tool support for use with the apparatus.

12. A method of claim 11 wherein the method includes using right-saw-and-left-saw-configuration-means of the cutting-tool support to configure and arrange the apparatus to enable a right-hand and left-hand portable power cutting-tool, as alternatives, to be attached to the cutting-tool support.

13. A method of claim 12 wherein the right-saw-and-left-saw-configuration-means includes both right and left configurations for the following:
the cutting-tool support and the tool-attachment-means therefor; and
the variable-angle mechanism;
and wherein the method includes using the right-saw-and-left-saw-configuration-means to alternatively configure or re-configure the apparatus between either a first arrangement adapted for use with a right-hand-saw and a second-arrangement adapted for use with a left-hand-saw.

14. A method of claim 13 wherein the method includes using clamping members of the tool-attachment-means to attach either a right-hand or left-hand saw to the cutting-tool support, such that the clamping members are alternatively attached to the cutting-tool support in either the first or second arrangements.

15. A method of claim 13 wherein the method includes, for the right hand arrangement, using fastening means of the right-saw-and-left-saw-configuration-means to releasably fasten the variable-angle mechanism to the cutting-guide at a location proximate one end thereof, and, for the left hand arrangement, using further fastening means of the right-saw-and-left-saw-configuration-means to releasably fasten the variable-angle mechanism to the cutting-guide at another location that is proximate the other end of cutting-guide.

16. A portable cutting-guidance apparatus adapted to be used with a portable power cutting-tool that has a cutting implement to enable the cutting-tool to cut an object at a variably selected angle, including:
portable positioning means adapted, in use, to be positioned motionless against an object to be cut by a portable power cutting-tool; and
a linear cutting-guide adapted to enable the portable power cutting-tool to travel on and along the cutting-guide in a straight line, the cutting-guide being provided with a cutting-tool support adapted to travel and reciprocate along the cutting-guide, and adapted to have the portable cutting-tool attachable thereto,
the cutting-tool support having tool-attachment-means that allows the portable power cutting-tool to be removably attachable thereto, such that the cutting-tool support, when the portable power cutting-tool is so attached, is able to reciprocate back and forth along the cutting-guide,
the cutting-guide being pivotally connected to the positioning means about a pivot point by a variable-angle mechanism that is adapted to adjustably fasten the cutting-guide to the positioning means at a variably selected angle relative to one another such that, in use, the portable power cutting-tool is able to travel on and along the cutting-guide to cut the object in a straight line at the variably selected angle;
wherein the apparatus is provided with saw-tilt-means that enables the saw blade, in use, to be tilted such that the plane of the saw blade is substantially non-perpendicular with respect to the support plane of the cutting-tool support.
